(19) United States
(12) Patent Application Publication
(10) Pub. No.: US 2020/0300412 A1
(43) Pub. Date: Sep. 24, 2020

(54) GROOVED COMPOSITE BLOCKS AND METHOD OF MANUFACTURE

(71) Applicant: IntegriCo Composites, Inc., Sarepta, LA (US)

(72) Inventor: Brian Arkwood, Sarepta, LA (US)

(21) Appl. No.: 16/826,037

(22) Filed: Mar. 20, 2020

Related U.S. Application Data
(60) Provisional application No. 62/821,874, filed on Mar. 21, 2019.

(51) Int. Cl. F16S 5/00; B29D 99/00

(52) U.S. Cl. CPC F16S 5/00; E01B 3/44; B29D 99/0003

(57) ABSTRACT

Embodiments of the present technology are directed to a grooved composite industrial block product. The industrial block products described herein may be manufactured from plastic materials. Methods for manufacturing such grooved composite block products are additionally described herein, and comprise filling a grooved block mold with a polymeric mixture comprising plastic materials. The grooved composite block products described herein may be utilized in various industrial applications, including as railroad ties and industrial matting.

### CROSS-REFERNCE TO RELATED APPLICATIONS

This application claims the benefit of and priority to U.S. Provisional Patent Application No. 62/821,874, filed Mar. 21, 2019, which is hereby incorporated by reference in its entirety.

### BACKGROUND

Efforts have been made recently to increase recycling and to use recycled materials in various products and end uses. Products made from recycled composite materials also positively contribute to the environment, as they reuse waste materials that would otherwise be sent for discarding into dumps or landfill waste areas. Manufacturing products from recycled composite materials has not been without challenges, however. Recycling processes can be more costly in certain situations, which has limited more large-scale adoption across certain product lines. Recycled composite materials have at times also lacked consistency, uniform quality, and desired structural integrity or characteristics to meet the demands of certain product specification requirements.

In the context of industrial products (e.g., railroad ties, industrial matting), there are unique demanding requirements that must be met. For instance, the products must be able to withstand insect and fungal attacks and exposure to outdoor elements, such as variable weather conditions, wide temperature variations, all types of precipitation, and extended exposure to ultraviolet radiation. At the same time, industrial products must exhibit certain structural characteristics, such as maintaining integrity even when subject to heavy loads. Therefore, the products generally need to exhibit some effective degree of stiffness, strength, toughness, and resistance to degradation. In the past, industrial products have been manufactured from a variety of materials, such as wood, metals, and concrete, but such materials suffer from deficiencies and fall short of fulfilling the demanding requirements of their end uses, such as those discussed above.

Plastic-based olefins, polymers, and composite polymer mixtures are alternative materials from which industrial products have been manufactured. They have been recognized to provide certain advantages over other materials, such as resisting degradation, even when subject to harsh conditions, and providing the requisite structural characteristics to fulfill the demands of industrial end uses. The cost of raw materials for plastic and composite plastic products can be expensive, however. Recycled plastic materials provide a more cost-efficient alternative to traditional virgin plastic raw material. However, recycled plastics and recycled composite plastic materials introduce variability in composition, and in turn, performance.

Recycled plastic materials generally comprise of HDPE (high-density polyethylene), PET (polyethylene terephthalate), PET/HDPE blends, PVC (polyvinyl chloride), polypropylene, and polystyrene, for example. Separating recycled materials according to resin type can be tedious and challenging, and thus expensive. Further difficulties may arise, in particular for composite plastic materials, in blending a comingled collection of different plastic types. Composite plastic materials that have been manufactured from a blend of comingled plastic types have at times exhibited disadvantageous characteristics, such as low-modulus of rupture and relative inflexibility.

### SUMMARY

Embodiments of the present technology are generally directed to industrial products manufactured from plastic materials, including virgin and recycled plastics, and methods for making the same. The embodiments of the present technology address the problems and deficiencies in the art, including those discussed herein. An embodiment of the industrial products of the present technology is a grooved composite block. The grooved block may be manufactured from one or more plastic materials, including a mixture of recycled plastic materials. The composite plastic material can be formed by: compressing one or more various types of plastic materials into a product mold, full melt molding, injection molding, extrusion molding, blow molding, semi-melt molding processes, rotational molding, or thermoforming. Additional features of exemplary embodiments will be described throughout, with reference to illustrative drawings.

### BRIEF DESCRIPTION OF THE DRAWINGS

The features of the technology will become more readily apparent, and may be better understood, by referring to the following detailed description and accompanying drawings, in which:

FIGS. 1A-1D provide perspective, top, side, and end views of a grooved composite block.

FIG. 2 is an end view of a mold for a grooved composite block.

FIGS. 3A-3D provide perspective, top, side, and end views of a bottom plate of a mold for a grooved composite block.

FIGS. 4A-4D provide perspective, top, side, and end views of a side plate of a mold for a grooved composite block.

FIGS. 5A-5C provide perspective, side, and end views of a push plate.

FIG. 6 is a graphic representation of shear rate versus shear stress for various types of materials.

FIG. 7 is a graphic representation of shear rate versus apparent viscosity.

### DETAILED DESCRIPTION

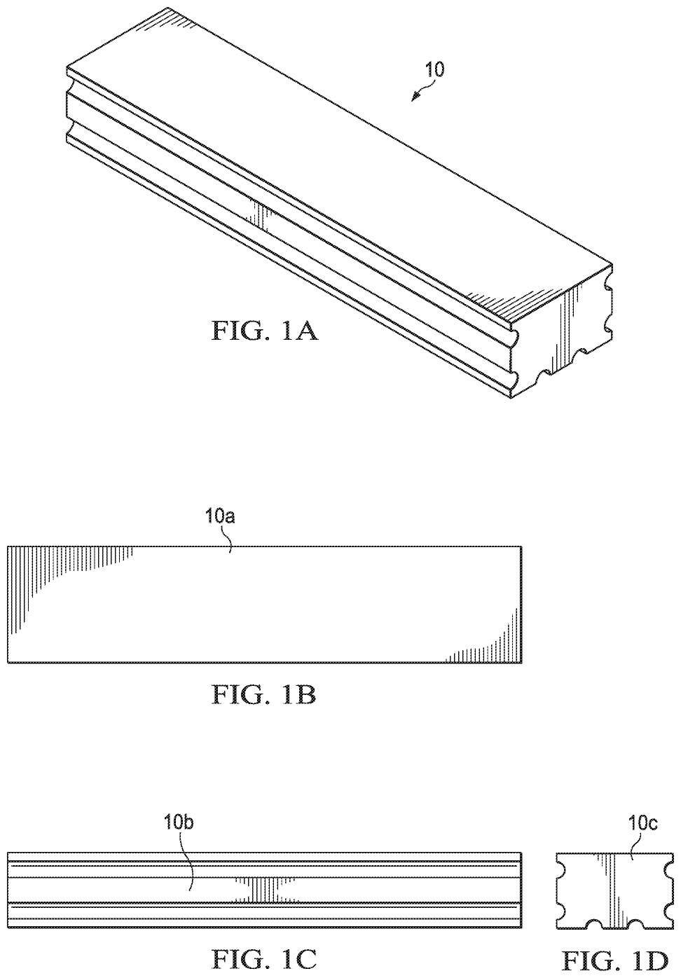

An embodiment of a grooved composite block 10 of the present technology is shown in FIGS. 1A-1D. A top view of the grooved composite block 10 shows the top surface 10a of the grooved composite block 10. A side view of the grooved composite block 10 shows the side (or lateral) surfaces 10b of the grooved composite block 10. An end view of the grooved composite block 10 shows one end 10c of the grooved composite block 10. According to the embodiment illustrated in FIG. 1, the grooved composite block 10 has a flat top surface 10a, grooved lateral surfaces 10b, and a grooved bottom surface. The grooves on the bottom and lateral surfaces of the grooved composite block 10 are semi-circular. In alternative embodiments, the grooves may be of a variety of geometries, including but not limited to the following: rectangular, squared, semi-elliptical, triangular, trapezoidal, reentrant. Embodiments of the grooved composite block 10 may have the same groove geometry on all surfaces or a combination of grooved geometries on different surfaces. While the top surface 10a of the grooved composite block 10 is smooth, it may also contain grooves in certain embodiments. Grooves on the composite block 10 may run parallel to the length of any side of the block or may be perpendicular to the length of any side of the block. In certain embodiments, the grooved composite block may contain: one or more grooves on one face, surface or end of the block; one or more grooves on multiple faces, surfaces or ends of the block; or one or more grooves on all faces, surfaces, and ends of the block. For avoidance of doubt, grooves on the composite block 10 may be included in any one or combination of orientations on any face or end of the composite block.

According to certain embodiments, the grooved composite block 10 may be shaped in a variety of geometries so as to provide variable cross-sectional geometries. For example, the grooved composite block 10 may be shaped such that its cross-section is, but not limited to, any of the following shapes: rectangular, triangular, hexagonal, trapezoidal, octagonal, square, “I”- shaped, “H”-shaped, “T”-shaped, and otherwise flanged geometries. The variable geometries provide advantageous structural integrity to the grooved composite block 10. Any of the aforementioned embodiments of the grooved composite block (e.g., variable geometric shapes) may contain grooves (e.g., one or more grooves on any surface and in any orientation, as described above).

The grooved composite block 10 of FIG. 1 may be manufactured from a variety of plastic materials, including for example, one or more types of virgin plastics or one or more types of recycled plastic materials. Other embodiments of composite blocks can be made of one or more types of virgin plastics, one or more types of recycled plastics or any combination of virgin or recycled plastics of various types in each category (i.e., category being virgin and recycled plastics). The plastic materials are directed into (i.e., flow into) a grooved block mold, wherein the plastic materials are compressed by a compression apparatus and then the grooved block mold is sealed to hold the plastic material under compression. Proper filling and compression of the mold promotes good polymer-to-polymer interaction, which in turn produces a composite block with more desirable properties.

The viscosity of the material entering the mold is a factor in compression and volume of plastic material in the mold. The higher the viscosity of the fluid, the more resistance there is to flow. In certain embodiments, having a lower viscosity can be advantageous in filling the mold. Plastic materials instantaneously decrease in viscosity with an increase in shear strain rate. Therefore, such materials flow more easily into the mold. Viscosity also contributes to the degree of interaction between the polymers of the plastic materials. A lower viscosity contributes to the polymers having a less voluminous shape and promotes better mixing of the polymers. The shear-thinning—i.e., the reduced viscosity produced by the increased shear strain rate—allows the high molecular mass molecules to be untangled and linearly oriented by the flow. At high shear strain rate and higher concentration, molecules may become more ordered and elastic. In such situations, the molecules have a less voluminous shape, which allows for better compression and higher concentration. Shear stress causes molecules to become stretched and compressed (at a right angle to stretch) resulting in a better orientation of the polymers.

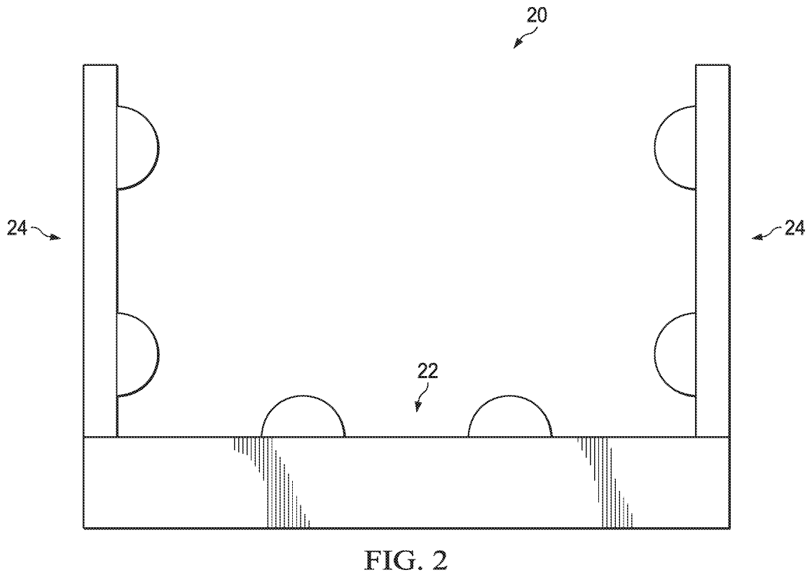

According to embodiments of the present technology, using a grooved block mold helps to increase shear stress during the compression molding process. This increased shear stress produces a final grooved composite block with the beneficial properties discussed above (e.g., increased polymer entanglement, higher molecular weight). FIG. 2 illustrates an embodiment of a grooved block mold 20. The grooved block mold 20 can be fabricated in parts or as a single component. The mold 20 in FIG. 2 is fabricated in parts: a bottom plate 22 and two side plates 24. The bottom plate 22 and side plates 24 include semi-circular ribs, which create the grooves in the final grooved composite block 10. These ribs inside the mold increase the shear stress as the plastic materials fill the mold 20. The ribs also decrease the overall volume of the mold, and resulting composite block. The finished composite block is, in this way, molded with grooves that match geometry of the ribs. As noted previously, embodiments of the composite block may comprise grooves of variable geometries, such as but not limited to semi-circular, rectangular, squared, semi-elliptical, triangular, trapezoidal, or reentrant. Likewise, embodiments of the composite block mold may comprise grooves of variable geometries. The ribs can be located on as many sides and in any orientation of the mold as desired in the finished product with spacing as determined for desired product properties and application. In certain embodiments, the mold 20 may comprise more or fewer side and bottom plates and may be configured so as to produce a grooved composite block having any one of the various geometries discussed previously (e.g., rectangular, triangular, hexagonal, trapezoidal, octagonal, square, “I”-shaped, “H”-shaped, “T”- shaped, and otherwise flanged geometries).

In certain embodiments, any one or more of the surface plates (e.g., bottom plate 22 or side plates 24) may be removable or hinged. For instance, one or both end plates may be removable so as to enable the grooved composite block to be ejected from the mold upon completion of the compression process. Alternatively, one or more of the side plates of the grooved block mold may be hinged or otherwise removable to enable connected opening and ejection of the grooved composite block through a lateral side of the grooved block mold (as opposed to ejection of the grooved composite block through one of the ends of the grooved block mold.

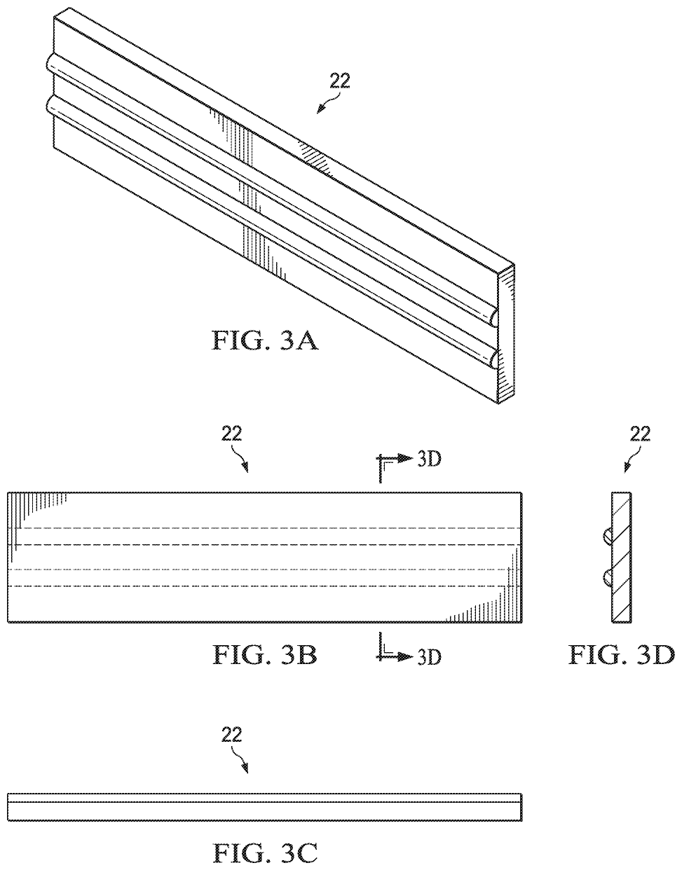

FIGS. 3A-3D illustrate an embodiment of the bottom plate 22 of the mold 20. The bottom plate 22 is shown from a bottom side view, a right side view, and a cross-sectional view. According to this embodiment, the bottom plate 22 comprises two semi-circular ribs on a top surface.

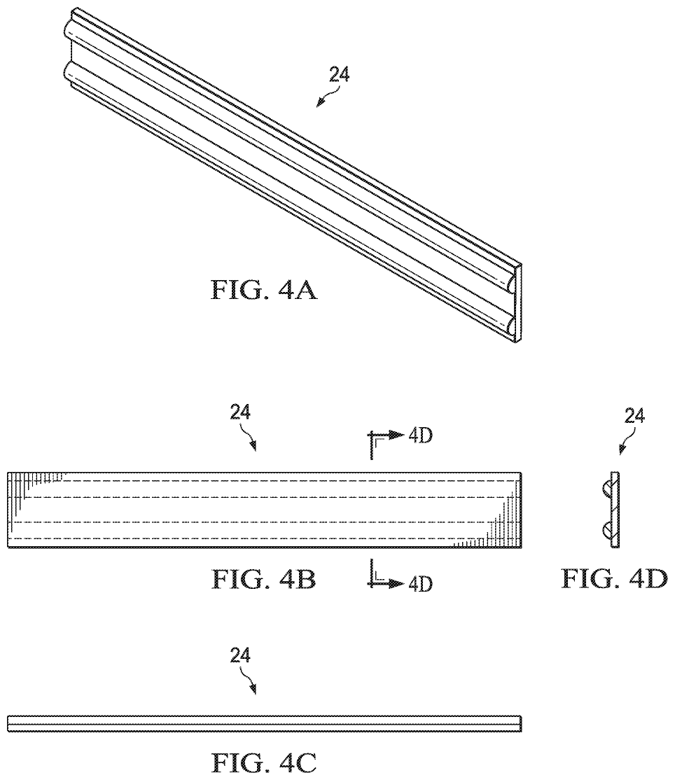

FIGS. 4A-4D illustrate an embodiment of the side plates 24 of the mold 20. An embodiment of the side plate is shown from a side view, a top view, and a cross-sectional view. According to this embodiment, the side plate 24 comprises two semi-circular ribs on one lateral surface. As shown in FIG. 2, the mold 20 is fabricated so that the lateral surfaces of the two side plates 24 on which the ribs are located face one another. In this way, the resulting composite block is formed with groves on both lateral surfaces.

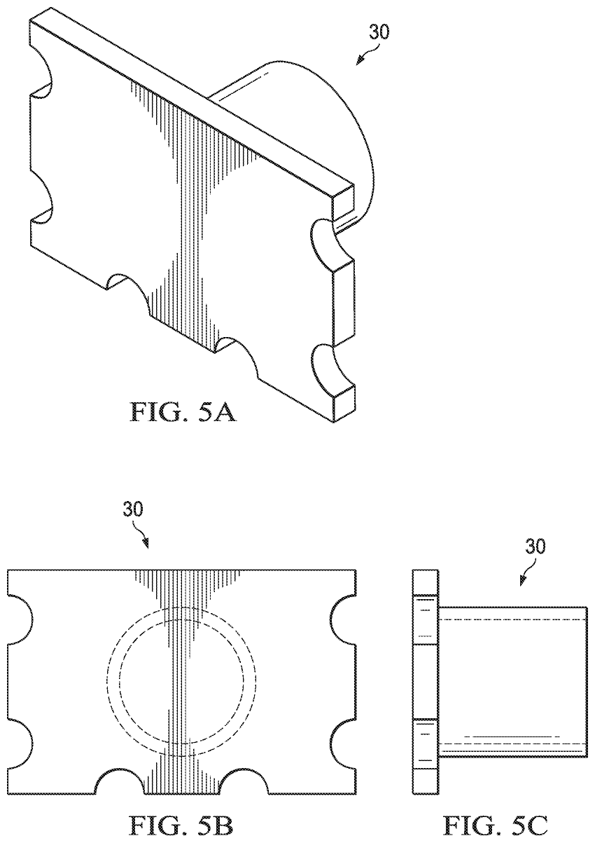

FIG. 5 illustrates an embodiment of a push plate 30. An embodiment of push plate 30 is shown from a front view and a right view. In certain embodiments, a hydraulic cylinder causes plastic material to enter a block mold. In other embodiments, the plastic material may be injected (e.g., pressure injected), poured, or otherwise introduced into the mold. In certain embodiments, the plastic material is introduced into the mold in its common state, and in other embodiments it may be introduced into the mold in a melted or semi-melted state. Push plate 30 may be located opposite of where plastic material enters a mold. It acts to contain the plastic material within the mold and seal at least one end of the mold. In certain embodiments, push plate 30 is air tight, such that even if the plastic material is in a fully melted liquid state, it will not exit the mold. In other embodiments, push plate 30 seals the mold, but is not necessarily air/liquid tight. Push plate 30 takes on the geometry defined by side plates 24 and bottom plate 22. For example, in the embodiment shown in FIG. 5, push plate 30 includes two grooves on each side to align with the two grooves on each of the side plates 24. Correspondingly, the embodiment of push plate 30 in FIG. 5 includes two grooves on a bottom to align with the two grooves on bottom plate 22. In some embodiments, plastic material may be pushed, loaded, injected, compressed or otherwise moved into the mold from an end of the mold such that the source material moves in a longitudinal direction along and into the mold. When ribs are present in the mold, this longitudinal direction may be parallel to the ribs running the length of the mold. Pushing or loading the plastic material into the mold and compressing the plastic material may be accomplished with the push plate 30. Moving the plastic material into the mold in this direction may serve to further increase entanglement of the plastic material due to the presence of the ribs. After plastic material enters the mold and completes curing within the mold, push plate 30 is used to push the composite block out of the mold. In certain embodiments, as alluded to above, the composite block may be ejected or otherwise removed from either end of the mold. In other embodiments, the composite block may be ejected or otherwise removed from the mold from the top, from the bottom, from any one or more lateral surfaces/faces.

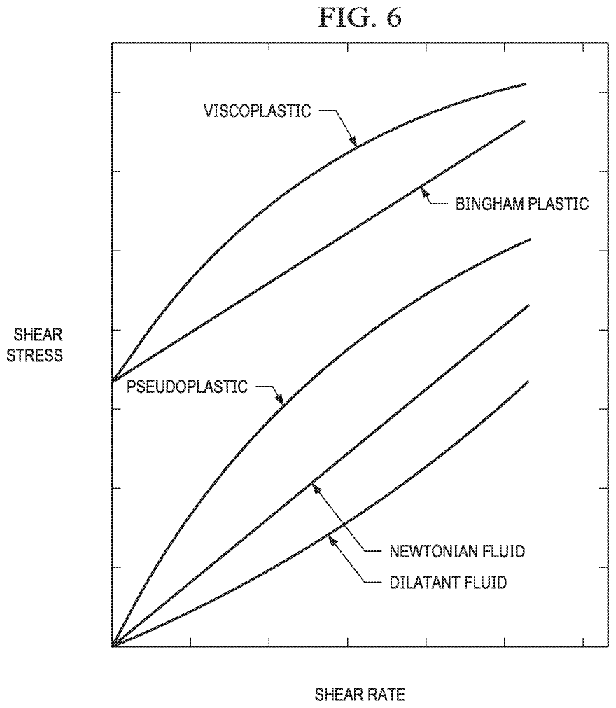

FIG. 6 illustrates the relationship between shear stress and shear rate for various types of materials—shear stress on the vertical axis and shear rate on the horizontal one. Shear rate is a measure of how the flow rate of the plastic material changes with distance from the walls of the mold. The viscoplastic, Bingham plastic, and pseudoplastic do not exhibit any shear rate (no flow and thus no velocity) until a certain stress is achieved. Shear stress can be applied by a number of means, including but not limited to increasing the velocity at which the mold is filled with the plastic material, increasing pressure, and adding grooves to the mold.

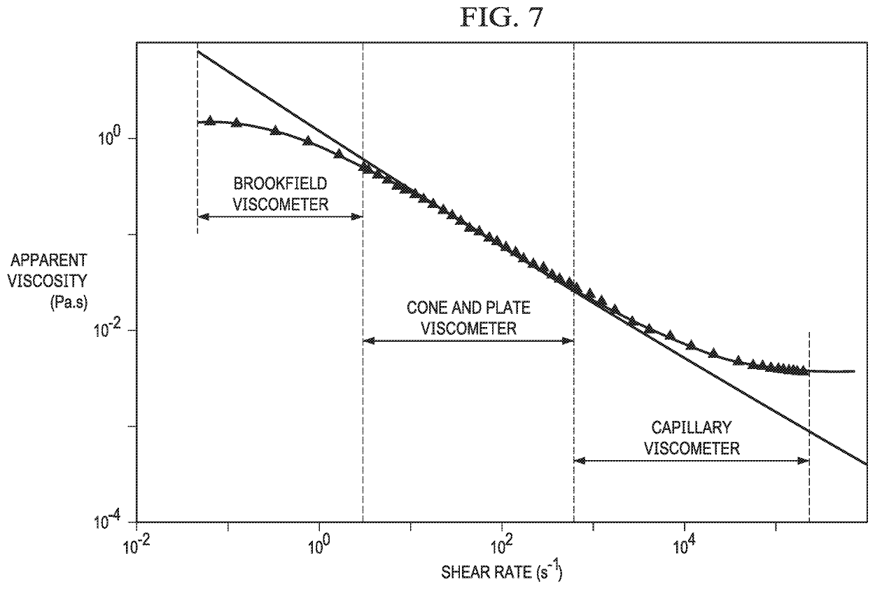

FIG. 7 illustrates the relationship between apparent viscosity and shear rate. As was illustrated in FIG. 6, when shear stress increases, so does shear rate. Comparatively, as illustrated in FIG. 7, when shear rate increases, apparent viscosity of a plastic mixture decreases. At lower viscosities, increased volumetric flow can be achieved. Volumetric flow rate is also dependent upon the cross-sectional area of the mold. The different types of viscometers referenced in FIG. 7 are exemplary of appropriate types that may be used to measure viscosity within variable viscosity and shear rate ranges.

The grooves in a finished composite block promote several benefits. The grooves reduce the cross-sectional area of the composite block, which allows the block to be made from less overall raw material and reduces manufacturing cost. As mentioned above, the increased in shear stress will increase entanglement and mixing of the plastic materials. The ribs in the mold decrease the volume, thus reducing the amount of recycled plastic material required to fill the mold. A reduction in raw material volume required to manufacture the final grooved composite block saves cost. After the grooved composite block is ejected from the mold, the block has more exposed surface area, which allows for more rapid transition of the polymeric material to its glass transition temperature (i.e., higher rate of cooling). The higher rate of cooling promotes more entanglement of the polymers from the recycled plastic materials.

The application of applying ribs in the molds to inherently produce grooves in the final product can be applied to any composite product manufactured through compression molding. In alternative embodiments, plastic materials may be melted (e.g., fully melted or semi-melted) into a liquid state and pressure injected into a block mold described above. In this way, embodiments of the grooved composite blocks described herein may be manufactured by extrusion processes or other full melt or semi-melt plastics manufacturing processes. One application of a grooved composite block, as described herein, is as a railroad tie. In that end use, the grooves create a product of similar cross-sectional area and section modulus, while at the same time provide a product that is lighter weight, that reduces stress in deflection under loading, and that exhibits higher lateral stability in ballasted track.

What is claimed is:

1. An industrial block product comprising:
a rectangular top surface;
a rectangular bottom surface comprising at least one groove spanning the length of the bottom surface;
a rectangular first lateral surface comprising at least one groove spanning the length of the first lateral surface;
a rectangular second lateral surface comprising at least one groove spanning the length of the second lateral surface;
a rectangular first end surface comprising at least three grooves, a first groove defined by the groove on the bottom surface, a second groove defined by the groove on the first lateral surface, and a third groove defined by the groove on the second lateral surface; and
a rectangular second end surface comprising at least three grooves, a first groove defined by the groove on the bottom surface, a second groove defined by the groove on the first lateral surface, and a third groove defined by the groove on the second lateral surface;
wherein the industrial block product is manufactured from a mixture of recycled plastic materials.

2. The industrial block product of claim 1, wherein at least two grooves are disposed on each of the bottom surface, the first lateral surface and the second lateral surface.

3. The industrial block product of claim 1, wherein all grooves extend the length of the bottom surface, the first lateral surface or the second lateral surface.

4. The industrial block product of claim 1, wherein the industrial block product is manufactured from a mixture of recycled and virgin plastic materials.

5. The industrial block product of claim 1, wherein the grooves include a semi-circular cross-section.

6. An industrial block product comprising:
a rectangular top surface;
a rectangular bottom surface;
a rectangular first lateral surface; and
a rectangular second lateral surface;
wherein at least one of the top surface, bottom surface, first lateral surface, and second lateral surface comprises one or more grooves, and wherein the industrial block product is manufactured from plastic material.

7. The industrial block product of claim 6, wherein one or more grooves is disposed on each of the bottom surface, the first lateral surface and the second lateral surface.

8. The industrial block product of claim 6, wherein at least one of the one or more grooves extends the length of the top surface, the bottom surface, the first lateral surface or the second lateral surface.

9. The industrial block product of claim 6, wherein the plastic material includes recycled plastic.

10. The industrial block product of claim 6, wherein the plastic material includes a mixture of recycled and virgin plastics.

11. The industrial block product of claim 6, wherein the one or more grooves includes a semi-circular cross-section.

12. A method of manufacturing an industrial block product, the method comprising:
molding a source material of recycled plastics into the industrial block product;
wherein the industrial block product includes a top surface, a bottom surface, a first lateral surface, and a second lateral surface;
wherein at least one of the top surface, bottom surface, first lateral surface, and second lateral surface comprises one or more grooves.

13. The method of claim 12 further comprising promoting entanglement and mixing of the source material as the material is compression molded.

14. The method of claim 12, wherein compression molding the source material further comprises:
pressure injecting the source material into a mold from an end of the mold such that the source material moves in a longitudinal direction.

15. The method of claim 14, wherein pressure injecting the source material further comprises:
pressing the source material into the mold using a push plate.

16. The method of claim 12, wherein the source material is provided during molding in a semi-melted state.

17. The method of claim 14 further comprising:
holding the source material in the mold under compression.

18. The method of claim 14 further comprising:
ejecting the industrial block product from the mold by pushing the industrial block product with the push plate.

19. The method of claim 14, wherein the mold includes at least one rib extending in the longitudinal direction corresponding to the one or more grooves formed in the industrial block product.
